(19) United States
(12) Patent Application Publication
(10) Pub. No.: US 2023/0180669 A1
(43) Pub. Date: Jun. 15, 2023

(54) COMPOSITION AND MANUFACTURING METHOD FOR A COMPOSTABLE FLORAL ARRANGEMENT MEDIUM

(71) Applicant: Smithers-Oasis Company, Kent, OH (US)

(72) Inventors: Paul Thomas KELLY, Cleveland Heights, OH (US); Sang Hyen PARK, Incheon City (KR); Gary LEGNANI, Kent, OH (US)

(21) Appl. No.: 17/924,751

(22) PCT Filed: May 14, 2021
(86) PCT No.: PCT/US21/32383

§ 371 Date: Nov. 11, 2022

Related U.S. Application Data
(60) Provisional application No. 63/026,209, filed on May 18, 2020.

(51) Int. Cl. A01G 5/02; A01G 24/44; A01G 24/23; A01G 24/28

(52) U.S. Cl. CPC A01G 5/02; A01G 24/44; A01G 24/23; A01G 24/28

(57) ABSTRACT

A method for producing a biodegradable floral arrangement media that includes obtaining a pre-formed mixture by mixing together: (a) a matrix of natural or inert inorganic fibers and/or powders; (b) a water insoluble, meltable compostable binder; and (c) optionally, additives; and heating the pre-formed mixture to fuse the binder with the matrix. Also, a biodegradable floral arrangement media made by the process, which is preferably compostable.

### BACKGROUND OF INVENTION

### Field of Invention

The present invention relates to flower arranging media for cut flowers. More particularly, the present invention provides an environmentally friendly, compostable media for cut flower arrangements.

### Description of Related Art

High performing flower arrangement media are generally rigid polymer foam articles. The most common type of floral foam is a phenolic foam as disclosed in U.S. Pat. No. 2,753,277. The polymers used to produce these floral foams are petrochemical based and are not readily biodegradable or compostable. There is a growing desire for flower arranging media that will readily decompose with the flowers in compost when the arrangement has reached the end of its usable life. Smithers-Oasis Company has marketed and sold floral foam with enhanced biodegradability, which is ideal for disposal in modern managed landfills, but has a biodegradation rate that may be regarded as too slow for industrial or “home” composting. Glass vases can be used to hold bouquets of flowers, but are not suitable for modern, artistic flower arrangements requiring unique angles and professional floral arrangement designs. Glass vase arrangements have the additional risk of water spills. Historically non-foam flower arranging media comprised of newspaper or moss, to provide a water source, and chicken wire to hold the flowers in place. This approach is messy, labor intensive and limited to simple floral arrangements. Arrangements using this method require frequent addition of water in order to maintain longer flower life. Reusable kenzan devices, which are also known as flower frogs or spiky frogs, have also been used for flower arrangements but have the major drawback of not holding flowers well in place during transport, in addition to the risk of water spills.

### BRIEF SUMMARY OF THE INVENTION

In view of the foregoing, the present invention is directed toward a method of manufacturing a compostable article comprised of natural organic fibers and/or powders, and/or inert inorganic materials bonded by a compostable polymer, in which the natural matrix materials are filtered, if necessary, to remove larger sizes, and subsequently blended with a compostable meltable polymer powder, poured into a mold or compostable base, and finally formed into usable shapes by applying heat or steam through the media to melt and fuse the polymer powder thereby resulting in a bonded media article able to hold inserted cut flowers in place, and having the further ability to absorb water and release the water to the cut flower stems inserted into the bonded media article.

This invention provides an environmentally friendly, compostable flower arranging media that has all the benefits of floral foam, namely low labor ease of use, water holding to prevent spills while promoting flower life, and flower holding for easy transport.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 provides a flowchart for the process to manufacture a compostable floral arrangement medium according to the invention.

FIG. 2 is a black and white photo of compostable floral arrangement bricks formed of a compostable floral arrangement medium according to the invention.

FIG. 3 is a black and white photo of compostable floral arrangement articles comprised of the compostable floral arrangement media according to the invention in a compostable base material.

### DETAILED DESCRIPTION OF THE INVENTION

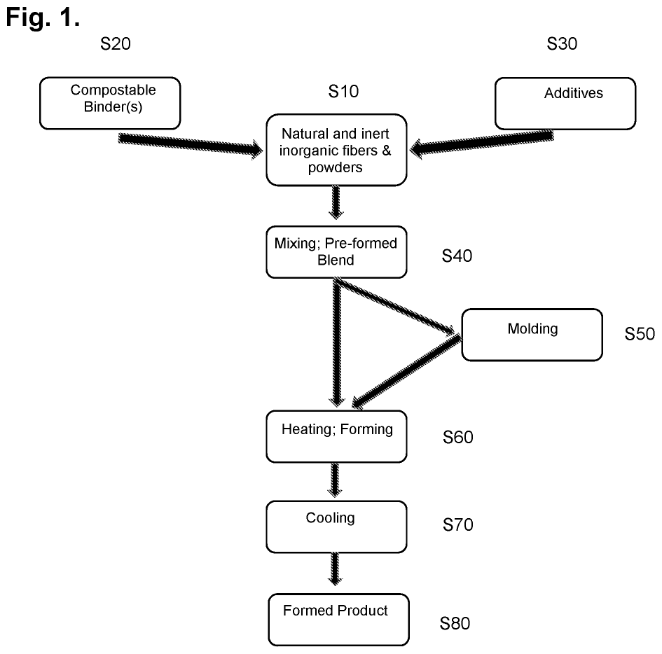

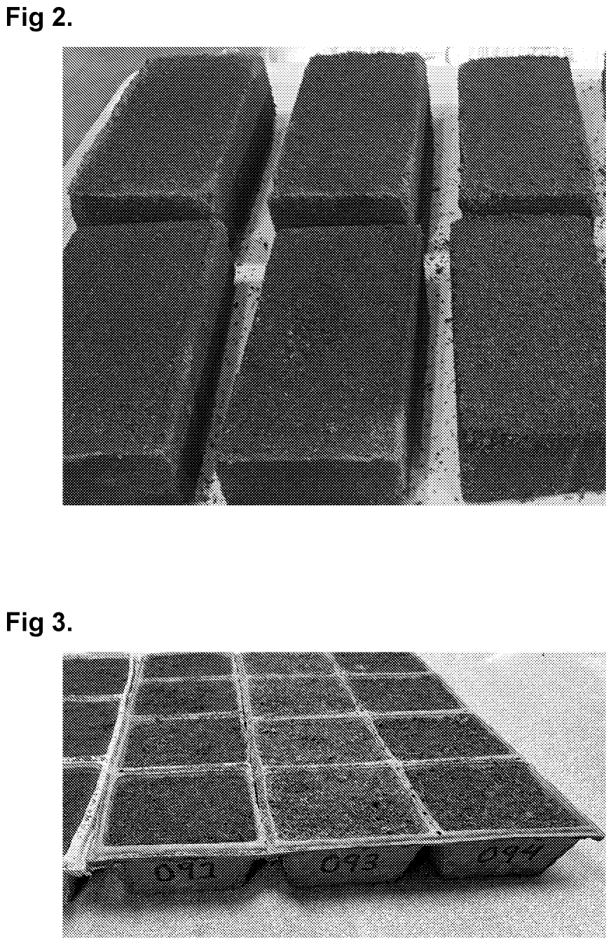

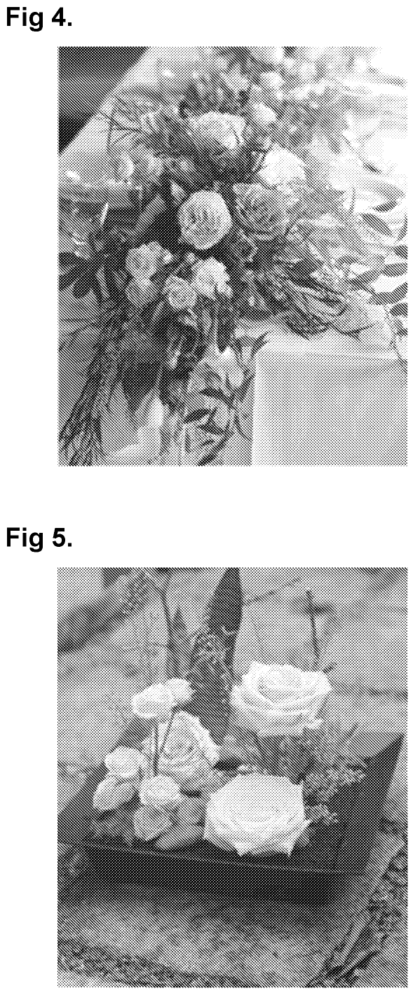

With reference to FIG. 1, a manufacturing method for a compostable floral arrangement medium according to the present invention comprises mixing a natural material fiber or powder matrix (S10) with compostable meltable binder(s) (S20) and other optional additives (S30) to form a mixed, pre-formed blend (S40); optionally placing the mixed, pre-formed blend in a mold (S50); heating the mixed, pre-formed blend (in the mold, if molded) using steam with a vacuum, microwave, radiant, or other methods (S60); followed by cooling the formed article (S70). The article is optionally demolded to obtain the compostable floral arrangement medium or article (S80). In one preferred embodiment of the present invention, the compostable floral media is obtained by adding the mixture (S40) into a mold with a perforated bottom plate or screen, which is subsequently placed in a steam chamber and heated to 100-150° C. by pulling the steam through the form via a vacuum process. This method is similar to that described in U.S. Pat. No. 7,712,252 for growing media. The molded product is then cooled and subsequently demolded. Examples of this embodiment are shown in FIG. 2. In another preferred embodiment of the present invention, the compostable floral media article is obtained by adding the mixture (S40) into a compostable container with optional holes, which is subsequently placed in a steam chamber and heated to 100-150° C. to fuse the binder and natural matrix, and subsequently removed to cool. Examples of this embodiment of the invention are shown in FIG. 3.

The present invention provides a compostable flower arrangement medium comprised of natural fibers or powders, and/or inert inorganic fibers or powders (S10) bonded by water insoluble, meltable compostable polymers (S20). Optional additives/components (S30) include, for example, biodegradable additives to promote faster water soaking time, to promote flower life, and processing aids.

The natural and inert inorganic fiber and powder matrix (S10) comprises between 30-90% (all percentages set forth herein are by weight, unless otherwise specified), preferably between 40-75%, and more preferably between 50-65% on a dry basis of the compostable floral arrangement media composition. Examples of natural and inert fibers and powders include but are not limited to coconut fiber, hemp fiber, cotton fiber, cellulose fiber, peat, and other natural fibers, waste materials from natural fiber processing, tannin powder, wood flour, waste materials from lumber processing, rice hulls, soybean hulls, other waste materials from grain processing, bentonite, montmorillonite, vermiculite, kaolin and other clay minerals, perlite, rock wool, and other inert inorganic materials, and blends of these materials. Depending on the type and composition of the fiber or powder used, the physical properties of the compostable floral medium may benefit from filtering out larger fibers or particle sizes to improve the effectiveness of the binder. Filtering through a 10-20 mesh filter has been observed to be beneficial in compostable floral media containing coconut fiber.

The water insoluble, meltable compostable polymer (S20) comprises between 10-70%, preferably between 25-60%, and more preferably between 35-50% on a dry basis of the compostable floral arrangement media composition. Examples of water insoluble, meltable compostable polymers include but are not limited to polylactic acid, polycaprolactone, compostable polyesters, polyhydroxyalkanoates, crosslinked meltable starch, other water insoluble compostable polymers, and blends of compostable polymers. The water insoluble, meltable compostable polymers are preferably ground to flow through a 100-mesh filter so as to provide better bonding with the natural and inert fiber and powder matrix (S10).

The additives (S30) comprises between 0-40%, preferably between 0-30%, and more preferably between 0.2-20%, of the compostable floral arrangement media composition. These ranges do not include water absorbed by the raw materials in S10 and S20. Examples of additives include but not limited to water for improved blending of the dry materials, wetting agents such as those commonly used in soil mixes, such as SOAX® supplied by Smithers-Oasis Company, in floral foam, or in personal care products to promote water absorption into the compostable floral arrangement media, flower food and other flower enhancing chemicals such as those sold by Floralife® to promote longer flower life and improve the appearance of a floral arrangement, or antimicrobial materials to inhibit mold growth on the media prior to end of use. Additives (S30) are added either to component (S10) prior to blending with the polymer binder (S20), or altogether.

Any mold that can withstand the heating process can be used in the molding step (S50). If the mold is designed to be used as a shipping or final use container for the compostable floral design medium, the mold must also withstand exposure elements such as water during the media soaking process by the user, and during the active use of the product prior to end of life disposal. Compostable molds can be made from a number of different materials such as compostable polymers for instance polylactic acid, compostable polyesters, polyhydroxyalkanoates, thermoplastic starch, cellulosic polymers and blends of compostable polymers, or composites comprised of compostable materials, or all-natural materials such as bark, dried cellulose pulp, fiber mats, or any other compostable material that can withstand the heating process and conditions during use. Compostable molds made from compostable polymers, compostable polymer blends, or composites containing these materials must be comprised of a compostable polymer or polymer blend with a higher melting temperature than the compostable polymer binder (S20). A continuous line, wherein the mixture (S40) falls onto a moving belt may also be used as the molding step. In this instance the heating step could be done within the mixing step, for instance a heated screw conveyor, or on the belt, for instance in a heated tunnel.

The fusion of the compostable polymer binder (S20) with the fiber/powder matrix (S10) is achieved through a heating process (S60). The mixture (S40) must reach a temperature above the melting point of the compostable polymer binder. This can be achieved through a number of different methods including the use of wet or dry steam as disclosed in U.S. Pat. No. 7,712,252 B2, convection ovens, microwave radiation, infrared radiation, heated screw conveyors, or any other suitable heating method. Preferred heating methods would require shorter heating times to minimize uneven drying and shrinkage of the fused product (S80).

The cooling process (S70) can be achieved through either natural ambient cooling, or through assistance such as the addition of cold water, the flow of cold air, through refrigeration, or any other suitable cooling operation. If the final product (S80) is achieved through a demolding process, care must be taken to ensure removal from the mold when the fused mixture temperature is below the temperature of the compostable polymer binder melting temperature.

A preferred embodiment of the present invention comprises 1) a washed and rinsed coconut fiber with a moisture content of about 65-80%, as is typically used in growing media, filtered through a 10-20 mesh filter, 2) polycaprolactone with molecular weight between 25,000-75,000 g/mol, which has been cryogenically ground and filtered through a 100 mesh filter, and 3) water containing a wetting agent added to the blend to achieve a total moisture content of between 55-70% so as to facilitate blending of the materials and promote a fast soaking time. If the moisture content of the mix is within the desired limits, the wetting agent is blended into the mix as a separate component. Components 1 and 2 are blended in equal parts by weight on a dry basis. The blended mixture is added into a lined mold with a screen bottom, or a fiber tray mold with holes in the bottom surface, with slight compression to fully fill the mold. The mold is then placed in a steam chamber and 100-150° C. steam is applied for 1-3 minutes while applying vacuum to pull the steam through the mold. The mold is then removed and air-cooled. The final compostable floral arrangement media can then either be used as-is if the mold is compostable or demolded prior to use.

The compostable floral arrangement article of the present invention can be used similarly to current practice with petrochemical based floral foams for flower arrangements. For instance, complex floral designs currently done with petrochemical floral foams that cannot be done with non-foam environmentally friendly approaches can be prepared using the article from the present invention. The article from the current invention can be used with a compostable base, such as “Biolit®” marketed by Smithers-Oasis Company or with natural cages for extra design support as is commonly used in environmentally friendly floral designs. Once the floral arrangement made with the article of the current invention has reached its end of use, the entire arrangement can be composted together if desired.

There are a number of standards for commercial/industrial compostability of plastics including ISO 17088, ASTM D6400, EN 14995, and AS 4736. They all require biodegradation (chemical degradation), disintegration (physical degradation), low ecotoxicity to plants, and a maximum allowed level of heavy metals. There are time constraints for biodegradation and disintegration to occur to ensure that the polymer has degraded sufficiently when the compost is ready for use. For instance, ASTM D6400 specifies 84 days as reasonable for disintegration and 180 days for biodegradation for industrial composting. The compostable floral arrangement material according to the invention will degrade into water, carbon dioxide, ammonia (when anaerobic conditions are present), and biogas. Natural, non-modified biopolymers (i.e. cellulose, lignin, and other materials described previously (S10)) are known to biodegrade quickly and are generally exempt from biodegradation testing in the certification of compostable synthetic materials. It is anticipated that through the use of certified compostable binders and additives, and a non-modified natural raw material matrix, as indicated in this invention, the floral arrangement media will likely obtain compostable certifications.

The key performance criteria for a floral arrangement media are keeping flowers in place and keeping the flowers alive and fresh looking for a minimum period of at least 3 to 4 days, and preferably 1 to 2 weeks depending on the flower type. By manipulating the type and amount of the natural matrix material and the compostable binder, one can manipulate the composite density, bonding of the matrix and insertion resistance, thereby enabling the insertion of floral stems while keeping them in place. FIG. 4 shows an example of an everyday floral arrangement using a particular embodiment of the invention. FIG. 5 shows an example of a floral arrangement for an event using a particular embodiment of the invention. In both cases it is clear that the media has sufficient strength to maintain the floral design.

The following examples are intended only to illustrate the invention and should not be construed as imposing limitations upon the claims.

### Example 1

7 parts by weight of coconut fiber which was filtered through a 16-mesh filter and 9 parts by weight of polycaprolactone powder (60,000 molecular weight) which was cryogenically ground and filtered through a 100-mesh filter, was blended with 6 parts of water. The blend was put into a 11×23×8 cm mold. The mold was steam heated until the polymer was sufficiently fused together and then cooled to room temperature. The finished article was found to absorb water in about 3 minutes and support the insertion of rose stems.

### Example 2

3 parts by weight of coconut fiber filtered through a 14-mesh filter was combined with 1 part by weight of rice husk powder (20-180 mesh), 3 parts by weight of water, and 2 parts by weight of polycaprolactone (60,000 molecular weight). The blend was put into a 11×23×8 cm mold. The mold was steam heated until the polymer was sufficiently fused together and then cooled to room temperature. The finished article was found to absorb water in about 30 minutes and support the insertion of rose and gerbera stems.

### Example 3

473.9 g Coconut fiber have a moisture content of 78.9% (100 g of dry coconut fiber) was blended with 73.0 g of polycaprolactone powder and 0.4 g of a polyglucoside wetting agent. The blend was poured into a biodegradable fiber mold with the upper dimension of 4.5″×4.5″, a bottom dimension of 3.5″×3.5″ and a height of 2.25″. The mold was exposed to dry steam for 3 minutes and allowed to cool at room temperature. The finished product (hereinafter referenced as “CFM3”), after drying, was demolded and weighed to determine the “dry weight”, and then float saturated by placing on top of a water bath. The time to fully saturate was recorded as “soaking time” in Table 1 below. A value less than 5 minutes is generally considered acceptable. The soaked product was then weighed to determine the water uptake (saturated weight minus the dry weight). The water uptake (in g) was divided by the product volume as estimated from the mold volume (in cubic centimeters) to give the percent water uptake per product volume. A value above 75% is generally considered to be acceptable. Oasis® Maxlife Standard Floral Foam was cut to the same shape as the molded CFM3 and tested similarly for comparison. The dry weight of CFM3 was divided by the product volume, as estimated from the mold volume, to calculate the density (recorded in Table 2). A rod insertion test was performed to simulate the resistance to insertion of a flower stem. The rod used was 5 inches long with a one quarter inch diameter and a 60° conical pointed end. The rod was connected to a Universal Test Machine load cell and was inserted into the sample at a rate of 50 mm/min to a depth of 20.0 mm. The maximum resistance is recorded in Table 2 along with three commercially available polymeric floral foams available for sale from Smithers-Oasis Company for comparison. CFM3 was evaluated for flower life using the following method: Flowers were received dry, the stems re-cut, and then hydrated in tap water overnight in a cooler set to 2-3° C. Roses were treated with an anti-botrytis agent prior to hydration. Six samples of CFM3 were soaked in tap water and placed into plastic trays. Half of the trays were filled with tap water to act as a reservoir. The stems were cut to a minimum length to allow for insertion into the media by about 2 cm. The flowers were graded subjectively on a daily basis for flower life (days until death). A flower was considered dead according to the following criteria: Rose—petals visibly wilted or petal color degradation or petal browning; Gerbera—visible wilting of stem (bent neck) exceeding 90 degrees or ray flowers visibly wilted (reflexed downward) or petal discoloration; Chrysanthemum—visible wilting of petals or petal color degradation or petal browning). The flower life of common flower types (Table 3) was at least 4 days and was considered acceptable.

TABLE 1
Water Properties

| | Soaking time | Water uptake/volume |
|---|---|---|
| | (minutes) | (%) |
| CFM3 | 2:10 | 79 |
| Oasis ® Standard Floral Foam | 0:28 | 99 |

TABLE 2
Density and Rod Insertion

| | Density | Max Resistance |
|---|---|---|
| | (Kg/m³) | (lbF) |
| CFM3 | 196 | 2.8 |
| Oasis ® MaxLife Deluxe | 27 | 1.4 |
| Oasis ® MaxLife Standard | 22 | 1 |
| Oasis ® Espuma MaxLife Deluxe (Colombia) | 20 | 1.9 |

TABLE 3
Flower Life (days)

| | Rose | | Gerbera | | | |
|---|---|---|---|---|---|---|
| | | ‘Sweet | ‘Pole | | Chrysanthemum | |
| | ‘Akito’ | Unique’ | Ice’ | ‘Plot’ | ‘Fuji’ | ‘Cremon’ |
| | white | pink | white | pink | white | green |
| CFM3 | 4.8 | 6 | 5.6 | 5.7 | 7.6 | 7.4 |
| CFM3 + water reservoir | 5.6 | 6 | 5.3 | 5.9 | 8.3 | 9.3 |

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

1-20. (canceled)

21. A method for making a floral arrangement, the method comprising inserting a cut end of a stem of a flower into a bonded biodegradable floral arrangement support media article by piercing the bonded biodegradable floral arrangement support media article with the cut end of the stem of the flower, wherein the bonded biodegradable floral arrangement support media article comprises a mixture of at least (i) a matrix of natural or inert inorganic fibers and/or powders and (i) a water insoluble meltable compostable binder, said mixture having been heated to a temperature sufficient to fuse the binder with the matrix and cooled or allowed to cool to thus form the bonded biodegradable floral arrangement support media article prior the insertion of the cut end of the stem of the flower thereinto.

22. The method according to claim 21, wherein the bonded biodegradable floral arrangement support media article is compostable.

23. The method according to claim 21, wherein the matrix of natural or inert inorganic fibers and/or powders in the mixture comprises between 30-90% by weight of the mixture on a dry weight basis.

24. The method according to claim 21, wherein the matrix of natural or inert inorganic fibers and/or powders in the mixture comprises between 40-75% by weight of the mixture on a dry weight basis.

25. The method according to claim 21, wherein the matrix of natural or inert inorganic fibers and/or powders in the mixture comprises between 50-65% by weight of the mixture on a dry weight basis.

26. The method according to claim 21, wherein the matrix of natural or inert inorganic fibers and/or powders in the mixture comprises one or more materials selected from the group consisting of coconut fiber, hemp fiber, cotton fiber, cellulose fiber, peat, waste materials from natural fiber processing, tannin powder, wood flour, waste materials from lumber processing, rice hulls, soybean hulls, waste materials from grain processing, bentonite, montmorillonite, vermiculite, kaolin, perlite, rock wool and blends of the foregoing.

27. The method according to claim 21, wherein the water insoluble meltable compostable binder in the mixture comprises between 10-70% by weight of the mixture on a dry weight basis.

28. The method according to claim 21, wherein the water insoluble meltable compostable binder in the mixture comprises between 25-60% by weight of the mixture on a dry weight basis.

29. The method according to claim 21, wherein the water insoluble meltable compostable binder in the mixture comprises between 35-50% by weight of the mixture on a dry weight basis.

30. The method according to claim 21, wherein the water insoluble meltable compostable binder in the mixture comprises one or more selected from the group consisting of polylactic acid, polycaprolactone, compostable polyesters, polyhydroxyalkanoates, crosslinked thermoplastic starch and blends of compostable polymers.

31. The method according to claim 21, wherein the water insoluble meltable compostable binder in the mixture has a particle size that permits it to flow through a 100-mesh sieve (0.149 mm) before it is fused with the matrix.

32. The method according to claim 21, wherein the bonded biodegradable floral arrangement support media article further comprises one or more additives selected from group consisting of water, surfactants, flower food, chemicals for promoting the life and appearance of cut flowers, and antimicrobial materials.

33. The method according to claim 21, wherein the mixture is heated above the melting point of the water insoluble meltable compostable binder to fuse the binder with the matrix.

34. The method according to claim 21, wherein the mixture is heated to fuse the binder with the matrix using a steam chamber, convection ovens, microwave radiation, infrared radiation or a heated screw conveyor.

35. The method according to claim 21, wherein, prior to being heated to fuse the binder with the matrix, the mixture is disposed into a compostable mold.

36. The method according to claim 21, wherein, prior to being heated to fuse the binder with the matrix, the mixture is disposed into a mold, and wherein, after the mixture has been cooled or been allowed to cool to thus form the bonded biodegradable floral arrangement support media article and prior to of the cut end of the stem of the flower thereinto, the bonded biodegradable floral arrangement support media article is demolded from the mold.

37. The method according to claim 21, wherein the cut flower remains fresh-looking for a minimum period of at least 3 days after the stem has been inserted into the bonded biodegradable floral arrangement support media article.

38. The method according to claim 21, wherein the method further comprises allowing the bonded biodegradable floral arrangement support media article to absorb water.

39. The method according to claim 38, wherein the cut flower remains fresh-looking for a minimum period of at least 1 week after the stem has been inserted into the bonded biodegradable floral arrangement support media article and the bonded biodegradable floral arrangement support media article has absorbed water.

40. The method according to claim 39, further comprising composting the floral arrangement including the cut flower and the bonded biodegradable floral arrangement support media article.
